(19) United States
(12) Patent Application Publication
(10) Pub. No.: US 2003/0018548 A1
(43) Pub. Date: Jan. 23, 2003

(54) System for economic-financial planning

(76) Inventors: Danilo Cattaneo, Castellanza (IT); Edoardo Coronetti, Milan (IT); Sergio Scardova, Garlate (IT)

Correspondence Address: James V. Costigan, Esq., HEDMAN, GIBSON & COSTIGAN, P.C., Suite 2003, 1185 Avenue of the Americas, New York, NY, 10036-2646, US

(21) Appl. No.: 09/835,886

(22) Filed: Apr. 16, 2001

(30) Foreign Application Priority Data
Feb. 7, 2001 (IT) MI2001A 000248

(51) Int. Cl. G06F 17/60

(52) U.S. Cl. 705/30

(57) ABSTRACT

A system for economic-financial planning, comprising a set of tables for a generic database which are compiled and connected, and constitute a model for implementing economic-financial and asset-and-liability planning; the model is a structure aimed at preparing the budget (20) and at automatic calculation of the cash flow (28) and of the asset-and-liability statement (27) by means of an application program of the type resembling an electronic spreadsheet, and moreover enables a series of analyses, comparisons and prints of standard and specific documents and forms.

The present invention refers to a system for economic-financial planning.

The economic-financial planning division guides the firm in the implementation of the budget.

From a macro-analysis of an enterprise or of a group, through a process of analysis of a top-down type, there are usually identified those areas that constitute the basis for the creation of a model with which to develop the budget process in order to obtain the greatest advantages.

However, the models of development currently in use are basically complex and do not envisage complete identification of all the departments and/or divisions which concur in the implementation of the budget for the creation of the company value.

In addition, the traditional tools apply normally to given sectors and are scarcely ever integratable in the various realities of software management.

A purpose of the present invention is thus to overcome the problems mentioned above, and in particular to indicate a system for economic-financial planning which enables implementation, within the enterprise, of a project which handles drawing-up of the budget in a timely way through a tool that can be fully integrated within any company reality and is compatible with the majority of electronic spreadsheets currently in use.

Another purpose of the present invention is to provide a system of economic-financial planning which makes it possible to create a model with which to develop the budget process, designed to be fully integratable with the accounting and/or administrative divisions of the enterprise in such a way as to carry out monitoring and analysis of variance.

A further purpose of the present invention is to indicate a system of economic-financial planning which will make it possible to identify all the functional departments/divisions that concur in implementation of the budget, providing the tools necessary for carrying out in the best possible way the said preparatory stage for creation of company value.

These and other purposes are achieved by a system of economic-financial planning according to claim 1, to which the reader is referred for reasons of brevity.

Advantageously, the system according to the invention hinges upon the operation of a software product operating in Windows® environment, which enables the user to enter a number of data, obtaining as a result pre-determined forms of processing of the said data. Specifically, the system enables any processing of asset-and-liability and financial data of enterprises or groups of enterprises to be obtained automatically (the so-called “software management”), entering, as input data, only economic data and their mode of collection and payment.

The product includes various models for profit and loss accounts and asset and liability statements, financial statements, and numerous economic, asset-and-liability, and financial indices, in order to enable processing of economic/asset-and-liability/financial data of both a historical and a forecast type, in order to obtain a valid model for economic and financial planning, and, in brief, for implementation of the budget in all its aspects.

The application program in question, which is designed for use on a personal computer, whether in isolation or as forming part of a network, uses a set of tables for generic databases drawn up (preferably, in Access®) and connected together, which constitute the model of implementation of economic, asset-and-liability, and financial planning, in accordance with the invention.

This is, in practice, an electronic spreadsheet which can be applied simultaneously to the PowerPlan® operating system, produced by the PowerPlan Corporation, in order to enable the user to have the application immediately available, the application in this case proving suitable for producing also other types of results obtained by the use of this application.

In actual fact, the application package PowerPlan® in itself, as basic program, amounts to an empty box of the type comparable to the Excel® program produced by Microsoft. To proceed with the above comparison, the program according to the present invention constitutes, in practice, a file for Excel®, even though, in the case where the user were to decide to exploit it using other electronic spreadsheets (and not PowerPlan®), the use would continue to be possible after minimal modifications, which are obvious to a person skilled in the branch, have been made to the system that forms the subject of the invention, without, however, any prejudice to the architecture and operating logic of the said system.

Further purposes and advantages of the present invention will emerge more clearly from the ensuing description, which regards an embodiment illustrated just to provide a preferred but non-limiting example of the system for economic-financial planning according to the invention, and from the attached figures, where:

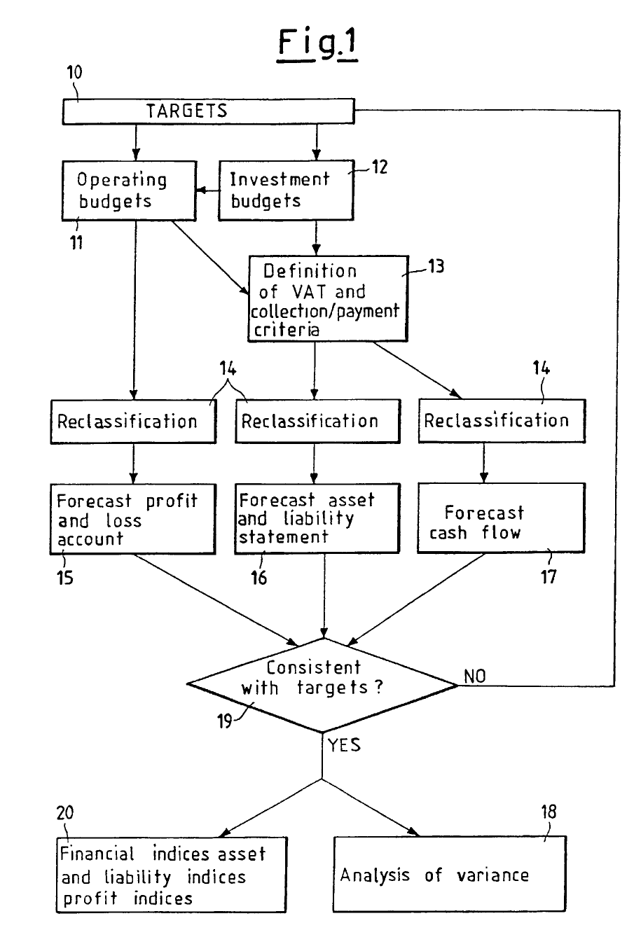

FIG. 1 is a block diagram of the working principle of the system for economic-financial planning according to the invention;

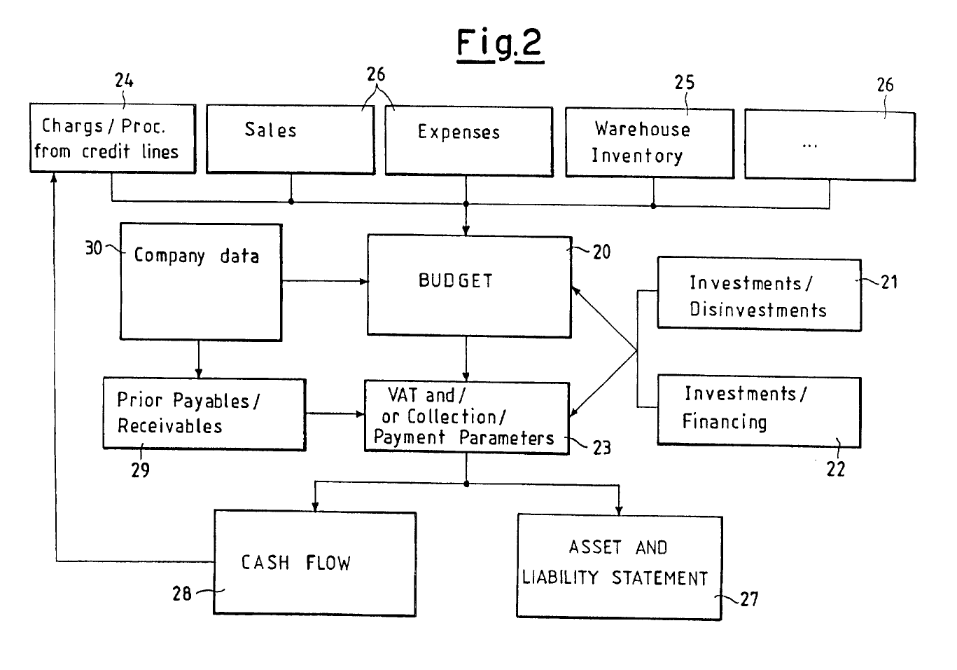

FIG. 2 is a block diagram of a practical example of embodiment of the working principle of the system for economic-financial planning according to the present invention;

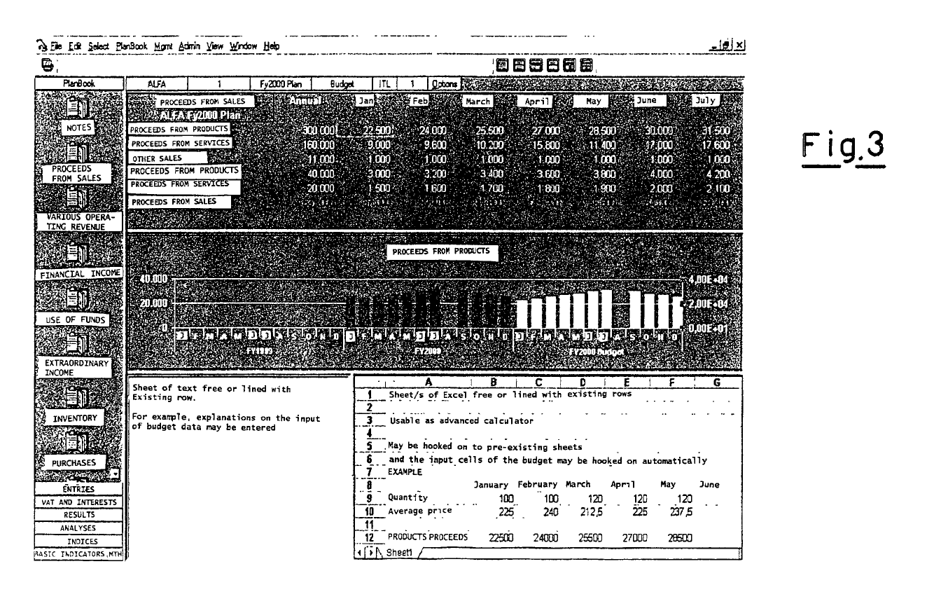

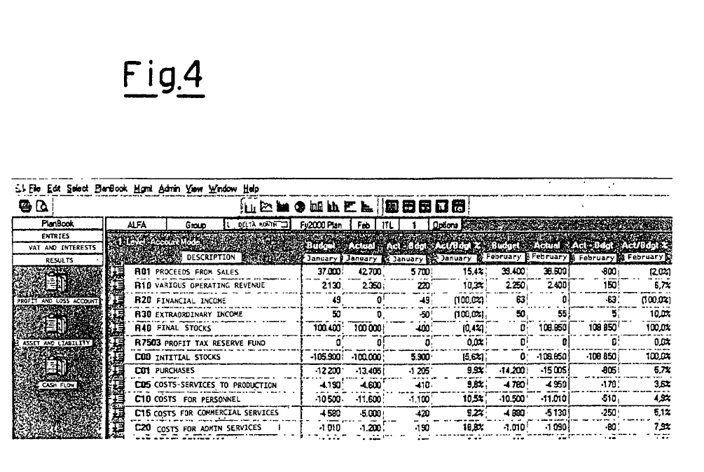

FIGS. 3 and 4 represent examples of screens which can be obtained on a personal computer and which correspond to steps of entry of data and retrieval of results, at least partial ones, following upon processing via the application program used in the system for economic-financial planning according to the invention;

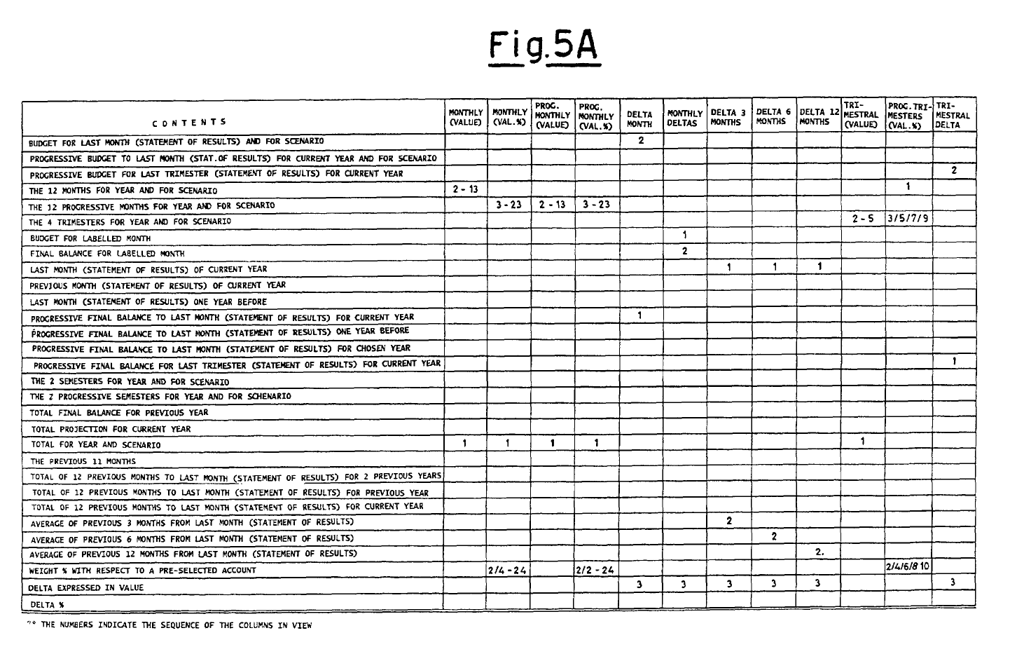

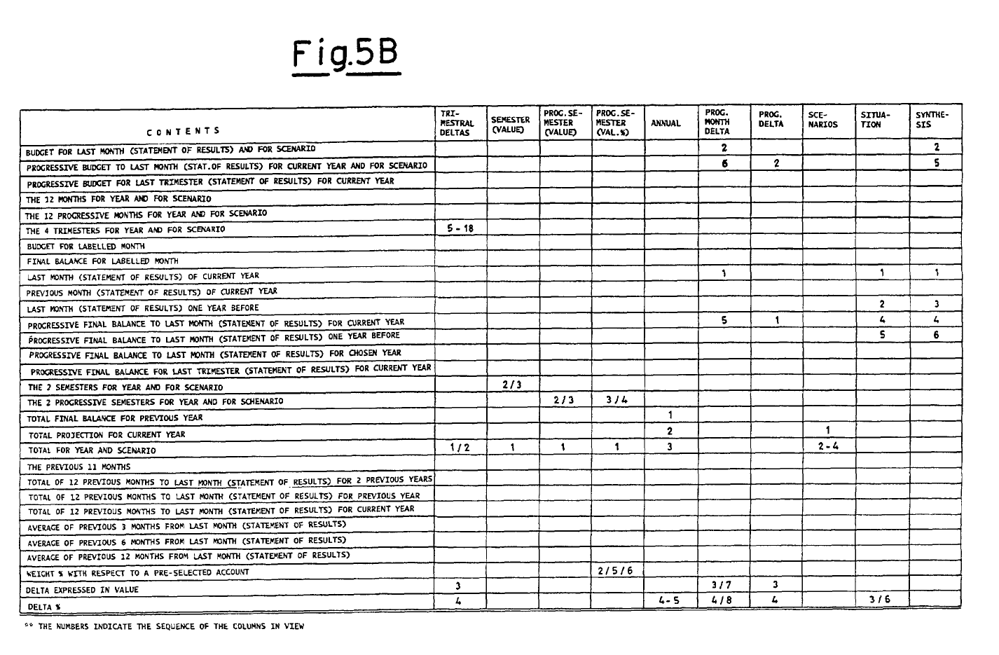

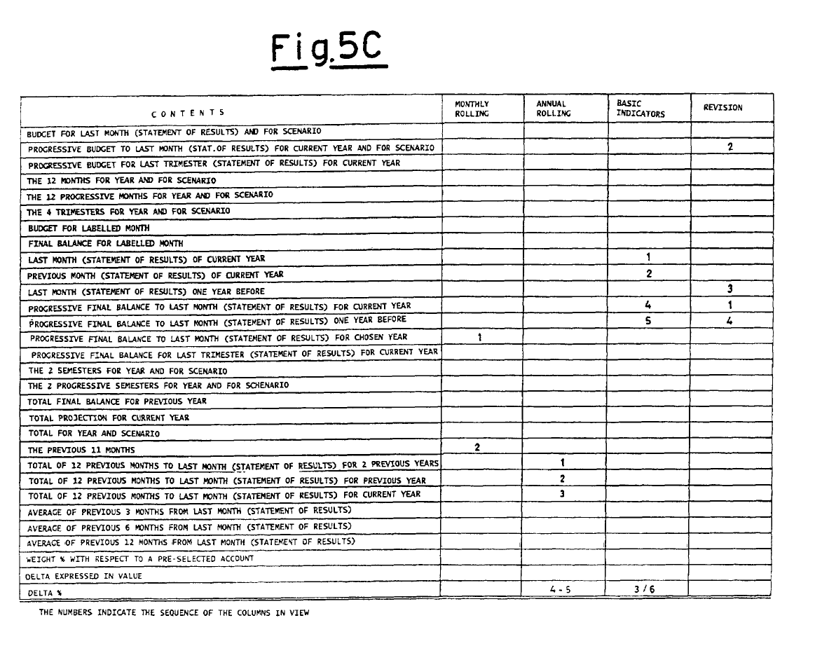

FIGS. 5A-5C show tables which give all the combinations of analyses available by means of the planning system according to the invention, and the indications regarding the arrangement of the data in the various columns;

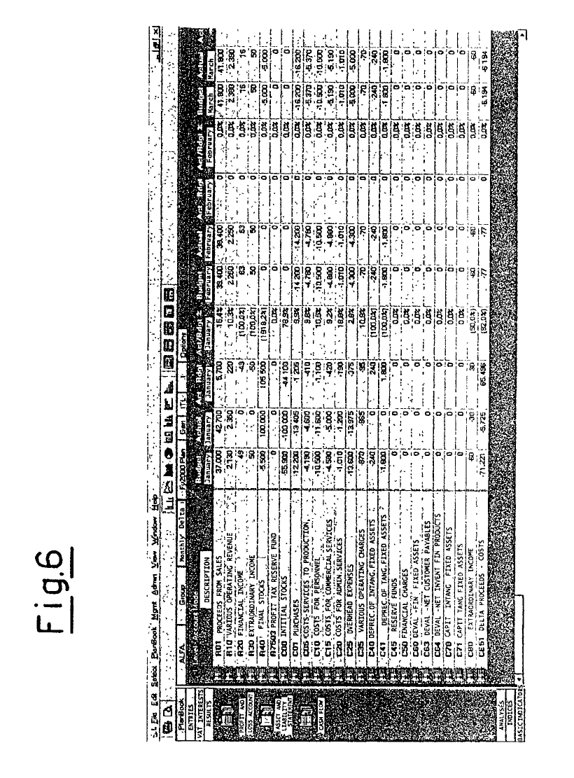

FIG. 6 is a first example of screen on a PC of a monthly analysis of variance between the final balance and the budget, obtained by means of the system for economic-financial planning according to the invention;

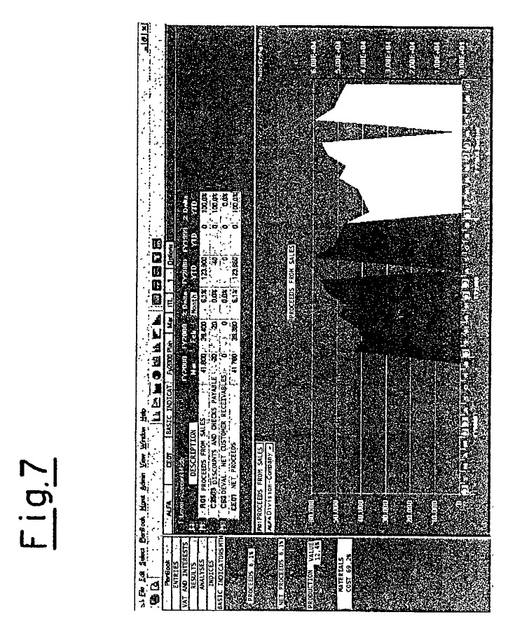

FIG. 7 is a second example of screen on a PC of a double graphical analysis of basic indicators which may be obtained by means of the system for economic-financial planning according to the invention; and

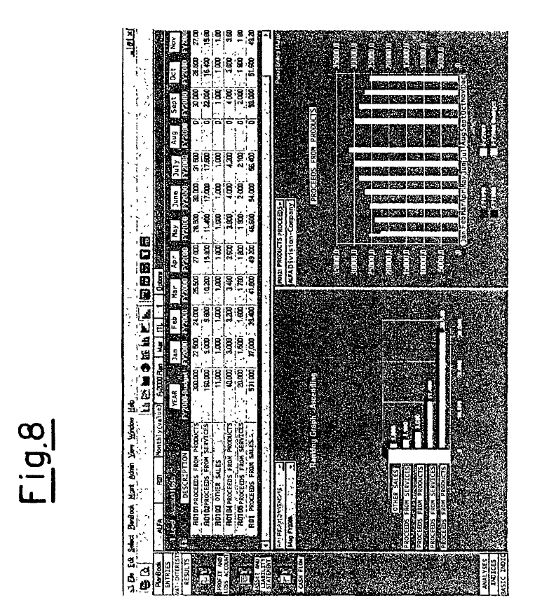

FIG. 8 is a third example of screen on a PC corresponding to the combination of two graphical analyses which may be obtained by means of the system for economic-financial planning according to the present invention.

The planning model which forms the subject of the present invention is a structure aimed at the preparation of the budget and automatic calculation of the cash flow and of the asset and liability statement. In addition, it enables a series of analyses, comparisons and prints of standard and specific documents and forms to be carried out.

The components used enable setting of a model, designing its structure and defining its logic, the elements that make it up (parameters, accounts, etc.), the properties of the elements, and the hierarchical and functional relations (formulas) that link them together. Furthermore, the said components enable handling of the data (manual entry, carrying-out of calculations, display and automatic and/or personalized analyses on the data processed) and importing of the same data, both budget data and final-balance data into PowerPlan® in an automatic way.

In practice, after the planning year and the targets set have been chosen (Block 10 of FIG. 1), there are entered, for each month, the basic data for the operating budgets (Block 11 of FIG. 1), which regard planning of the characteristic management of the enterprise (in terms of physical and economic flows of materials, components, finished products, and services coming into and going out of the firm) and the basic data for the investment budgets (Block 12), which regard the new commitments in terms of financial and human resources for achieving the targets 10.

The sequence of the categories of costs, proceeds, investments, and parameterizations comprises all the company balance-sheet variables, among which proceeds of various kinds, use of funds, value of warehouse inventory, purchases, company overhead expenses, various charges and expenses, reserve funds, devaluations, capitalizations, property, forms of financing, returned goods, interests, compensations, marketing expenses, consultancy, insurance, business trips, licences, etc.

To each elementary input data item, the user associates filling-in of a mask, by means of which he defines, at a yearly and/or monthly level, the VAT rate (standard or personalized), the criterion (manual method, method with initial balance or personalized method of monthly extensions according to the particular profiles of the various customers), and the modalities for collection (Block 13 of FIG. 1), for revenue accounts, and the modalities of payment for cost items (in time and expressed as percentages).

The model also accepts a possible entry of data for accounts belonging to an external accounting procedure as subaccounts of its own basic accounts, which are the sum of the said subaccounts. In this way, it is possible to provide an economic-financial planning following a proposed model, or else by detailing a basic model at the level of the company's own accounting (Blocks 14 of FIG. 1).

Once the various parameters have been defined, the model draws up a budget estimate (Block 15 of FIG. 1), according to the scalar method, and then, for each item corresponding to the parameter entered, checks what have been the VAT rates and what are the terms of collection and payment in time.

For example, if a payment is to be made after thirty days starting from January (i.e., in February), the cells for the month of January are checked and, if the value 1 is found in the cell (months of extension X), the amount multiplied by the cell for the part amount (percent extension X) will be placed in the corresponding cell for February; no ties exist for extension of collections or payments, and preferably five possibilities of extending a payment in time are envisaged (since, then, it is a cycle, it is possible to offer an unlimited number of possibilities).

The model developed, then, extends in time the part amount chosen of the taxable income with VAT. Furthermore, for each account, the system develops and checks whether it is a cost or an income, splits the VAT according to whether it is a payable (debt) or a receivable (credit), and creates the corresponding double entry, this being reflected in the drafting of the asset and liability account. In the case where the system finds a debit VAT balance, it automatically proceeds to settling it, zeroizing the VAT account and debiting the amount to the bank according to the mode of settlement chosen by the user.

All the double entries developed are connected to the accounts of the asset and liability statement in such a way that the summations of the double entries define the overall asset and liability statement. The items of the amounts extended in time which may reflect upon incoming and/or outgoing cash are connected to the accounts of the cash-flow scheme, which is fed by summation of its connected components.

In this way, starting from a charging of a budget estimate (Block 15 of FIG. 1), a forecast asset and liability statement is obtained (Block 16), and a forecast cash flow (Block 17).

The system is structured in such a way that, in a matrix, the accounts and formulas are arranged in the rows, and the time is arranged in the columns (Every twelve months the year changes). This makes it possible to fill in the form not only with budget data but also with final balance data.

It is thus possible to develop tables the effect of which on an electronic spreadsheet is to compare the same different total or partial aggregate account and/or accounts (for example, statements of profit and loss, margins, cash flows, asset and liability statements) for individual months (or sets of months), obtaining an analysis of variance (Block 18 of FIG. 1), taking into account the consistency (Block 19) with the targets 10.

Having available the elementary bookkeeping accounts it is further possible to create a section dedicated to the analysis of the most widely known indices of economic literature, divided into financial indices, asset-and-liability indices, and income indices (Block 20).

In practice, the system in its most general configuration may be adapted to individual entities or groups of companies, to which it supplies economic, financial, and asset-and-liability forecasts, consolidated or aggregated, with group or normal VAT liquidation.

In preferred non-limiting embodiments, which are here provided purely by way of example of the present invention, the planning system uses a series of menus and submenus represented on a screen of the personal computer (PC), from which there may first of all be obtained the identification and registration data regarding the organizational structure (Block 30 of FIG. 2) to which the model is to be applied. In particular, it is possible to display a tree structure of the company at a number of levels. In particular, the ensuing description and the screens containing the entered data and the results obtained (FIGS. 3, 4, 5A. 5B, 5C, 6-8) refer to an implementation of the system according to the invention applied to the PowerPlan® electronic spreadsheet. However, as has already been recalled, the same quantitative results may equally be obtained using other electronic spreadsheets after the obvious modifications that may be necessary have been made.

The highest level may be represented by a mother company of a group, and the level below this by the various companies that make up the group, which in turn may be made up of further branches. In this case, it is possible to talk of aggregated or consolidated units.

Other structures, for example of a geographical type, may be represented for the purpose of analyzing the data from other points of view.

The possibility of modifying the organizational structure does not present any particular limits. The tree-type organizational structure enables breaking-down of the budget into partial planning sets, automatic consolidation, and multi-dimensional navigation among the data.

A further icon of the application program displays, on the PC screen, in the form of a synthesis, the structure of the elements used for constructing the model of economic-financial planning. After the organizational structure, this icon enables description both of the operating logic and of the calculating logic with which the application is developed.

In the screen section where the budget data are hypothesized (Block 20 of FIG. 2), a set of data are entered.

First of all, data regarding prior payables (debts) and/or receivables (credits) are entered (Block 29 of FIG. 2), as well as data regarding investments and disinvestments (Block 21) in tangible and intangible fixed assets, where the former envisage indirect depreciation, and the latter direct depreciation. Consequently, in the disinvestments, the capital gains/capital losses are calculated, respectively, on the values of the assets reduced by the depreciated amount and on the residual values.

In general, the new investments and disinvestments have the role of varying the asset side of the asset and liability statement (fixed assets), the liability side in the case of indirect depreciation (reserve funds), and the banks for the payment, whilst the capitalizations and devaluations change the asset side (fixed assets) and the statement of profit and loss.

Another section is dedicated to the entry of the data on financing, both medium- to long-term financing and short-term financing (Block 22 of FIG. 2).

In general, the reimbursements of capital shares for prior financing and possible new financing are entered either manually or by importing them, in this section, and determine the liability side (reduction of payables and increase of debts with banks), whilst reimbursements of the amounts of charges and expenses are also entered automatically in the profit and loss account.

In the section called “Banks”, the flows deriving from collections/payments are handled (Block 23) in order to be able to determine the position of the accounts and the consequent calculation of charges and proceeds (Block 24), starting from the data regarding the effective annual mean active rate of the current account/accounts, regarding the portfolio advances and other credit lines, and regarding the total credit and average rate. Once entry of credits and rates has been completed, the model calculates also a descending scale of economic advantage, starting from the most advantageous credit, which is used for coverage in the event of negative cash flow.

In addition, the model enables corrections to be made on the use of the forms of credit, adapting them to the forms of collection that feed the various types of credit. The result of the section is the synthesis of the total effective annual mean rates both for liquidity and for financing.

In the warehouse-inventory section (Block 25), the model automatically calculates the final and initial inventory (stocks), entering the incoming stocks and the outgoing stocks. The said inventory (final and initial stocks) will then feed the statement of profit and loss and the assets.

The section called “Profit and loss account” displays on the PC screen the plan of the statements of profit and loss at the level of which it is intended to carry out planning. The various statements of profit and loss are partly calculated by the previous sections and partly entered from outside (either manually or by importing them) and can take into account additional structures, such as product and price, personnel and wages, etc.

At drafting of the final balance, further detailed accounts may be added (Blocks 26) coming from the company plan of accounts from which the accounting data are to be imported (for example, the accounts regarding purchases, raw materials and detail of prices). Consequently, the final balance may be drawn up at this new hierarchical level, and the summation of the details is compared with what has been planned at the level of the main account.

Further parameters may be used in given calculation formulas (for example, the month of the opening balances or the data item corresponding to VAT. In addition, it is also possible to enter distribution parameters to be applied automatically in time to specific economic items.

In the part of the model in which the basic calculations necessary for processing the final results are carried out, the interests are calculated for completion of the economic forecast (statement of profit and loss) with charges and proceeds deriving from the dynamics of the financial flows and the determination of the monetary flows divided according to categories of origin, which enables cash analyses that can be carried out during examination of the asset and liability statement.

The results of the model are constituted by the asset and liability statement (Block 27), calculated starting from the determination of the flows, as indicated previously, and from the cash flow (Block 28), which is directly derived from the flows and structured in such a way as to enable drawing-up of the final balance by means of programs for management of financial accounting.

Once the trend of the cash flow has been obtained and examined, it is possible to hypothesize investments (uses) other than simple availability in current account and, then, at this point, additional data may be entered on the investments (uses) of the available cash.

The sections of the model regarding the analyses of the profit and loss account and of the asset and liability statement, as well as the indices, make it possible to carry out reclassifications, calculations of margins, reports, and other operations on all the economic, asset-and-liability, financial, and economic-financial data.

Using the PowerPlan® application program, it is possible to manage the representations of the screens of the results in which, in addition to the data, also graphs may be present, as well as a text serving as a guide for filling in the budget category, and an electronic spreadsheet.

An example of screen from which the maximum representation is obtainable is shown in FIG. 3. In this case, the icon which has been activated and which is called “Proceeds” represents a category of incoming data which are entered either manually or automatically by means of other management application programs.

In general, the following are obtained: display of the scenario (in the case in point, the budget for the tax year 2000) on which the user is working, the elements involved in the tree structure obtained previously, the annual total (mean value or value of a final period of the tax year), and the monthly data.

In addition, it is possible to enter a value directly in the annual column (the datum is automatically shared out in the other columns, varying the content thereof proportionally) or a data item in a cell (the item in question may be expanded in the other cells according to various criteria).

The last part concerning the entry of data regards a series of items in which the system is supplied with the criteria whereby all the elements making up the cash flow are to be collected or paid In practice, all the budget items that make up the asset and liability statement are converted into financial flows.

Once the data and parameters have been entered into the system, it is possible to obtain the results in the desired formats and with the desired analyses.

In particular, it is possible to display the entire calculation for VAT, its liquidation and the corresponding payment, and the category of the items of origin may be highlighted both for VAT that is to be received and for VAT that is to be paid.

In addition, the logic and calculations used for determining asset rates, liability rates, and the use of credit, the dynamics that has led to the computation of banking charges and proceeds may be illustrated, whilst the receivable interests and payable interests that have been calculated complete the economic forecast and update the asset and liability statement and the cash flow.

The “Results” section represents the series of profit and loss accounts, subaccounts, and the asset and liability statement, with the accounts and subaccounts both of the assets and the liabilities, whilst the analysis screens provide display of the variance of the data on which the final balance has been drawn up and which have been planned in the various chosen periods.

In particular, FIG. 4 presents an analysis-of-variance table used for displaying the planned values, the final-balance values, and the variance expressed both in value and as a percentage.

The tables of FIGS. 5A, 5B and 5C instead contain all the combinations of analyses available in the model and the indications regarding the availability of the data in the various reference columns.

The analysis shown in the model proposed takes up again the values of the profit and loss account according to a scalar logic, with the aim of highlighting certain important margins for the purpose of management.

Finally, it is to be noted that the entire model functions according to monthly deltas, i.e., according to the same logic with which the budget is entered. Consequently, also in the phase of drawing-up of the final balance, the monthly movements must be entered.

From the above description, the characteristics, as well as the advantages, of the system for economic-financial planning which forms the subject of the present invention emerge clearly, and are in particular the following:

overall development of the forecast cash flow and the forecast asset and liability statement, starting from a forecast statement of profit and loss;

management of economic-financial and asset-and-liability planning of individual entities or groups of entities, simply by means of consolidation and/or aggregation of parts without any need to change software or model, but simply by filling-in a parameterization table; and

operation of the mathematical model irrespective of any particular type of specific accounting, and possibility of using the accounting as a source of data, supplying forecast data which may also be used by other applications.

Finally, it is clear that numerous variations may be made to the system in question, without thereby departing from the principles of novelty inherent in the inventive idea, just as it is likewise clear that, in the practical implementation of the invention, the materials, forms and dimensions of the items illustrated may be any whatsoever according to the requirements, and the said items may be replaced with others that are technically equivalent.

1. A system for economic-financial planning of a type comprising a software application program which enables the user to enter data, having as result pre-determined processing of the said data, characterized in that it uses a set of data-base tables compiled and connected by means of said application program, which may be likened to an electronic spreadsheet.

2. A system for economic-financial planning according to claim 1, characterized in that said system makes it possible to obtain automatically any processing of asset-and-liability and financial data on enterprises or groups of enterprises by entering, as input data, only economic data and their modes of collection and payment.

3. A system for economic-financial planning according to claim 1, characterized in that it comprises a series of models of statements of profit and loss, asset and liability statements, and financial statements, and a plurality of economic, asset-and-liability, and financial indices in such a way as to enable processing of economic/asset-and-liability/financial data of both a historical type and a forecast type, in order to obtain a model that is valid for economic-financial planning and, in particular, for budget analyses.

4. A system for economic-financial planning according to claim 1, characterized in that said electronic spreadsheet is applied simultaneously to a pre-set operating system so as to enable the user to have available various displays of the results.

5. A system for economic-financial planning according to claim 1, characterized in that it comprises a planning model designed for drawing-up the budget (20) and for automatic calculation of the cash flow (28) and of the statement of assets and liabilities (27), starting from the data regarding the operating budgets (11) of one or more enterprises and regarding the investment budgets (12).

6. A system for economic-financial planning according to claim 5, characterized in that said model associates, to each input datum, the filling-in of a mask, so as to define, at an annual or monthly level, a VAT rate, a criterion of extension, and modes of collection (13), said model further providing for the automatic liquidation of the debited VAT balance, modifying in this way said asset-and-liability and financial balances according to the pre-set modes of liquidation.

7. A system for economic-financial planning according to claim 6, characterized in that, once the input data have been defined, said model draws up a forecast statement of profit and loss (15) and checks VAT rates and terms of collection and payment in time, obtaining a forecast statement of assets and liabilities (16) and a forecast cash flow (17), starting from a forecast statement of profit and loss (15).

8. A system for economic-financial planning according to claim 6, characterized in that it is structured so as to make available, in a series of matrices or tables, the accounts and formulas arranged on the rows and time arranged on the columns, said matrices containing budget data and final-balance data that can be compared.

9. A system for economic-financial planning according to claim 6, characterized in that said input data regard at least prior payables (debts) and/or receivables (credits) (29), investments and disinvestments (21), various forms of financing (22), flows deriving from collections/payments (23), charges and proceeds (24), use of credit, incoming stocks and outgoing stocks (25), company detailed accounts (26), imported accounting data, and calculation parameters.

10. A system for economic-financial planning according to claim 9, characterized in that said model carries out calculations of interest, to complete an economic forecast with charges and proceeds deriving from the dynamics of financial flows, and determines the monetary flows, divided according to categories of origin, in order to obtain cash analyses that can be performed during the examination of the asset and liability statement.
